(19) United States
(12) Patent Application Publication
(10) Pub. No.: US 2020/0376714 A1
(43) Pub. Date: Dec. 3, 2020

(54) MICRO-PARTICLE-SIZE THERMOPLASTIC MICRO-AIRBAG POLYURETHANE ELASTOMER MATERIAL AND PREPARATION THEREFOR

(71) Applicant: NANTONG DE NEW MATERIAL CO., LTD., Jiangsu (CN)

(72) Inventors: Qiaojian CHEN, Shanghai (CN); Yanglong GUO, Shanghai (CN)

(73) Assignee: NANTONG DE NEW MATERIAL CO., LTD., Jiangsu (CN)

(21) Appl. No.: 16/636,629

(22) PCT Filed: Aug. 1, 2018
(86) PCT No.: PCT/CN2018/098030

§ 371 Date: Feb. 4, 2020

(30) Foreign Application Priority Data
Aug. 4, 2017 (CN) 201710660424.4

(51) Int. Cl. B29B 9/12; B29B 9/06; C08J 9/00; C08J 9/12; C08J 9/14

(52) U.S. Cl. CPC B29B 9/12; B29B 9/065; B29K 2075/00; C08J 9/122; C08J 9/141; C08J 9/0004

(57) ABSTRACT

A thermoplastic micro-porous polyurethane elastomer material with a micro particle size and a method for preparing the same are provided. The material comprises, by weight, 1-97% of support frame polymer material, 1-97% of pressure-resistant low-resilience polymer material, 0.01-0.5% of nucleating agent, and 0.1-10% of foaming agent. The method comprises the following steps: (1) is feeding polymer materials and the nucleating agent from the front end of a double-screw extruder, feeding the foaming agent from the middle, hot-melting and fully mixing all the raw materials, then further homogenizing hot melt in a static mixer, and afterwards, controlling the pressure of the hot melt and quantitatively delivering the hot melt by a melt pump. (2) is pelletizing the hot melt entering an underwater pelletizing chamber from the melt pump via a die, separating particles carried out by process water, and screening and drying the particles to obtain a target product.

### TECHNICAL FIELD

The invention relates to the field of preparation of polymer materials, in particular to a thermoplastic micro-porous polyurethane elastomer material and method for preparing the same.

### BACKGROUND

Thermoplastic polymer elastic materials have been widely used for manufacturing facilities, equipment, tools and consumables for production and daily use. With the development of society, more and more light materials are needed to meet the requirements for environmental protection, energy saving, and consumption reduction. A large quantity of thermoplastic polymer elastic materials, such as foamed polypropylene (PP), foamed polyethylene (PE), foamed polystyrene PS (PS), foamed polyester (PRT), foamed polyamide (PA) and foamed polyurethane (TPU), start to be subjected to lightweight experiments and verification to be further applied and popularized. Existing common processes for foaming thermoplastic polymer elastomers include: casting die foaming, injection foaming, extrusion foaming, autoclave foaming, and the like. The injection foaming uniformity and the injection foaming rate are low, and extrusion foamed materials are prone to pore breakage and surface collapse due to melt fracture. Foaming in the autoclaves has high safety risks and low productivity. There are physical foaming and chemical foaming according to the foaming principle. The foaming process typically includes bubble forming, bubble expansion, and bubble curing and shaping, and the like, irrespective of which polymer material is used or which foaming procedure is implemented.

To maintain good physical properties of foamed and expanded thermoplastic polymer elastomer materials, the structures and pores of expanded materials need to be designed. However, due to the constraints of structural properties and processing technologies of the materials as well as the comprehension of the foaming principle, control over the expanded thermoplastic polymer elastomer materials in China is simple and instable, and particularly, stable control over the properties and processing technologies of materials such as nylon, PET, PPT and thermoplastic polyurethane are hardly available. In addition, the particle size of existing foamed materials is difficult to control.

### SUMMARY

The objectives of the invention are to overcome the defects of the prior art by providing a thermoplastic micro-porous polyurethane elastomer material with a micro particle size, and method for preparing the same.

The objectives of the invention are realized through the following technical solution:

One objective of the invention is to provide a thermoplastic micro-porous polyurethane elastomer material with a micro particle size. A formula of the thermoplastic micro-porous polyurethane elastomer material with a micro particle size comprises, by weight, 1-97% of support frame polymer material, 1-97% of pressure-resistant low-resilience polymer material, 0.01-0.5% of nucleating agent, and 0.1-10% of foaming agent.

As a preferred embodiment, the support frame polymer material is a high-molecular weight or high-hardness polymer material, and the pressure-resistant low-resilience polymer material is a low-molecular weight or low-hardness polymer material corresponding to the support frame polymer material.

As a more preferred embodiment, the support frame polymer material is high-molecular weight thermoplastic polyurethane, and the pressure-resistant low-resilience polymer material corresponding to the support frame polymer material is low-molecular weight thermoplastic polyurethane;

or, the support frame polymer material is a high-hardness thermoplastic polymer elastomer (such as TPU, TPE or rubber as the case may be), and the pressure-resistant low-resilience polymer material corresponding to the support frame polymer material is a low-hardness thermoplastic polymer elastomer.

As a more preferred embodiment of the above technical solution, the molecular weight Mw of the high-molecular weight polyurethane is 8×10⁴-5×10⁵, and the molecular weight Mw of the low-molecular weight polyurethane is 2×10⁴-2.5×10⁵;

The shore hardness of the high-hardness thermoplastic polymer elastomer is 80 A-75 D, the shore hardness of the low-hardness thermoplastic polymer elastomer is 30-85 A, and in this case, the high-hardness thermoplastic polymer elastomer and the low-hardness thermoplastic polymer elastomer are preferably similar materials in general.

As a preferred embodiment, the nucleating agent is at least one selected from carbon nano-tubes, silicon dioxide, talcum powder, modified calcium carbonate, carbon black and tetrafluoroethylene powder;

The foaming agent is at least one selected from CO₂, N₂, n-butane, n-pentane and isopentane.

As a preferred embodiment, the particle size of the polymer elastomers is 0.5-2 mm.

On the basis of the above formula, other functional assistants such as a light stabilizer and an anti-oxidant can be selectively added to the thermoplastic micro-porous polyurethane elastomer material with a micro particle size to obtain required material performance.

The thermoplastic micro-porous polyurethane elastomer material with a micro particle size can be prepared through a conventional foaming process (such as foaming in an autoclave) on the basis of the formula. The other objective of the invention is to provide a new method for preparing the thermoplastic micro-porous polyurethane elastomer material with a micro particle size, in addition to the conventional foaming process. The new method comprises the following steps:

Feeding the support frame polymer material, the pressure-resistant low-resilience polymer material and the nucleating agent via a feed inlet at the front end of a double-screw extruder, feeding the foaming agent from the middle of the double-screw extruder, hot-melting and fully mixing all the raw materials, then further homogenizing hot melt in a static mixer, and afterwards, controlling the pressure of the hot melt and quantitatively delivering the hot melt by a melt pump; and

Pelletizing the hot melt entering an underwater pelletizing chamber from the melt pump via a die, separating particles carried out by process water, and screening and drying the particles to obtain a target product.

As a preferred embodiment, the inlet pressure of the melt pump is controlled to 100-150 bar, the pressure of the process water in the underwater pelletizing chamber is 6-40 bar, and the rotating speed of a pelletizer in the underwater pelletizing chamber is 3000-8000 rpm.

As a further preferred embodiment, the particles are carried out by the process water through a multi-stage pressure-relief expanding process water pipe with a pressure decreased gradually. More preferably, the multi-stage pressure-relief expanding process water pipe is a four-stage process water pipe, wherein a first-stage process water pipe has a water pressure of 6-40 bar, a second-stage process water pipe has a water pressure of 5-35 bar, a third-stage process water pipe has a water pressure of 4-30 bar, and a fourth-stage process water pipe has a water pressure of 3-20 bar.

As a more preferred embodiment, the die is of a porous plate structure, wherein pores in the porous plate structure have a diameter of 0.1-1.9 mm.

According to a more specific preparation method, the double-screw extruder is driven by a motor to operate at a speed of 50-900 rpm, a cylinder of the extruder is set to a temperature of 160-300° C. to make sure that the thermoplastic polymer can be fully hot-melted, the polymer and the nucleating agent are fed via the screw feed inlet at the front end, and the foaming agent is fed via the screw feed inlet in the middle. After being mixed, the materials are heated in the extruder and sheared by a screw to be hot-melted and enter the static mixer after being fully mixed by the screw, the melt is further homogenized and cooled in the static mixer to make sure that the temperature of the melt is controlled within 120-280° C. as required by the physical properties of a finished product. The melt pump is used for controlling the pressure of the melt and quantitatively delivering the melt, and the inlet pressure of the melt pump is controlled within 100-150 bar and the pressure of the melt in a screw cavity of the extruder is controlled to be stable to make sure that the hot melt of the foaming agent and the nucleating agent is fully mixed and homogenized in a controllable high-pressure environment. The high-pressure hot melt is stably fed into a die of the extruder through the pressure control and quantitative delivery functions of the melt pump, wherein the die is of a porous plate structure, and a uniform heating facility is arranged in the die to make sure that the hot melt can stably flow through the die. The hot melt delivered out by the melt pump under a high pressure enters an underwater pelletizing chamber via pores of the die and is cut into bean-like particles by a pelletizing cutter rotating at a high speed, wherein the pelletizing cutter in the underwater pelletizing chamber cuts the hot melt underwater. A 6-40 bar pressure generated by 10-90° C. process water under the effect of a process water pump enters the underwater pelletizing chamber via a process water inlet pipe of the underwater pelletizing chamber, so that the high-pressure hot melt is rapidly cooled by the high-pressure process water and is cut into particles by the pelletizing cutter, wherein the rotating speed of a pelletizer in the underwater pelletizing chamber 8 is controlled to about 3000-8000 rpm. A pressure difference between the hot-pressure hot melt and the high-pressure process water can be adjusted by means of the inlet pressure of the melt pump and the pressure of the variable-frequency process water pump to make sure that the initial expanding speed and rate of the polymer cut into particles are controllable and stable in the whole process. In consideration of a short cooling time of the polymer particles and a large difference in crystallization speed of materials in different formulas, the multi-stage pressure-relief expanding process water pipe is particularly designed in this process. According to the principle that the strength and pressure borne by the outer surface of the granular polymer increase along with the increase of the retention time in the process water, the water pressure in the first-stage process water pipe is maintained at 6-40 bar, so that the granular melt is partially cooled and is initially expanded in the presence of a pressure difference. The water pressure in the second-stage process water pipe is decreased to 5-35 bar by increasing the diameter of the pipe and decreasing the length of the pipe, in this case, the granular melt is further cooled, the strength of the outer surface of the melt is improved, and the melt is expanded again with the increase of the pressure difference. The resistance in the third-stage process water pipe is reduced to decrease the water pressure to 4-30 bar by increasing the diameter of the pipe and decreasing the length of the pipe, in this case, the granular melt is cooled again, the strength of the outer surface of the granular melt is further improved, the granular melt is expanded again with the increase of the pressure difference, and the expanding speed is decreased to be low because particle crystallization is about to be finished. The resistance in the fourth-stage process water pipe is reduced to decrease the water pressure to 3-20 bar by adjusting the pipe diameter and length of the pipe, in this case, the granular melt continues to be cooled, the strength of the outer surface of the melt is further improved, the granular melt is expanded again with the increase of the pressure difference, and the outer diameter of the particles is constant and stable because the cooling time is long enough, the strength of the outer surfaces of the particles is very high and particle crystallization is almost finished.

The expanded granular polymer enters a centrifugal separator together with water, water and expanded particles are separated in the centrifugal separator, then the expanded particles enter a vibrating screen and then enter a post-treatment system, and eventually, the process water flows out of the centrifugal separator to enter a process water tank. The process is conducted continuously and repeatedly in this way. High molecular weight and low molecular weight involved in the combination of high-molecular weight polymer and low-molecular weight polymer are used for distinguishing two polymer materials with different physical properties, that is, as for two polymer materials with different physical properties, the one with a high molecular weight is defined as a high-molecular weight polymer, and the one with a small molecular weight is defined as a low-molecular weight polymer; and high hardness and the lower hardness involved in the combination of high-hardness polymer and low-hardness polymer are defined by analogy. More preferably, the molecular weight of the high-molecular weight polymer is at least one time greater than that of the low-molecular weight polymer, and the hardness of the high-hardness polymer is over 10 A greater than that of the low-hardness polymer.

In the present invention, the pressure-resistant low-resilience polymer material mainly used for rebounding is an elastomer polymer material such as TPU, rubber and TPE, and the support frame polymer material mainly used for supporting is an elastomer polymer material or a non-elastomer material such as PET and PTT.

Unless otherwise particularly specified, raw materials and process steps in the present invention can be any raw materials or processes known by those skilled in the art. For example, the thermoplastic polyurethane is a commercially-available product or is prepared according to a known process. More preferably, the thermoplastic polyurethane is polyether-type thermoplastic polyurethane or polyester-type thermoplastic polyurethane as required by products.

When the thermoplastic micro-porous polyurethane elastomer material with a micro particle size is prepared, the size and density of internal pores of expanded particles and the forming mode, size and density of pores in the expanded particles and in the surfaces of the expanded particles are designed and controlled through material selection and proportion optimization, bubble of hot-melted polymer melt are controlled to expand by means of the pressure in the screw cavity of the double-screw extruder and the pressure of the extruder, and finally, the bubbles are controlled to be cured and shaped by means of the pressure difference between the melt and the process water and pressure relief of the process water.

According to the invention, in the aspect of raw materials, a high-molecular weight polymer and a low-molecular weight polymer, a high-hardness polymer and a low-hardness polymer, a high-crystallized polymer and a low-crystallized or amorphous polymer, or a high-polarity polymer and a low-polarity polymer or non-polar polymer are combined and are then mixed and hot-melted, then a foaming agent is added into the polymers which are controllably expanded, and finally, a composite expanded material has a twining and inter-penetrating air duct structure formed by a support assembly of an airtight micro-porous structure and an open foam assembly by means of the difference in foaming capacity of the foaming agent in polymer materials with different physical properties. Wherein, numerous airtight micro-pores with a size of 0.01-20 μm are formed by the high-molecular weight, high-hardness or high-crystallized polymer and the foaming agent under the effect of the nucleating agent and form the support assembly in the foamed material, the low-molecular, low-hardness or low-crystallized/non-polar polymer and the foaming agent form (non-airtight) open micro-pores and are partially expanded to form a pressure-resistant low-resilience assembly, and these open pores form air ducts surrounding the airtight micro-pores in the foamed material, and the air ducts are partially communicated and extend to the surface of the foamed material. In this way, when the foamed material is squeezed, the airtight micro-pores in the support assembly are squeezed to fulfill a support effect, and air in the open pores of the pressure-resistant low-resilience assembly is rapidly squeezed out to make sure that the foamed material is soft; and when the squeezing force is eliminated, the airtight micro-pores support the foamed material to restore, and external air is sucked into the open pores accordingly.

In addition, when the thermoplastic micro-porous polyurethane elastomer material with a micro particle size is prepared, the size and quantity of micro-pores and the size, shape and quantity of open pores in the foamed material can be controlled by means of the permeability difference of the foaming agent in different polymer materials, the strength difference of melt caused by different pressure differences and melt crystallization speeds of different materials, and the difference in changes and reservation of physical properties of different foamed polymer materials, so as to adjust the physical properties of the material to meet different purposes and different customer requirements.

In the preparation process, when larger open pores are needed or the proportion of open pores is insufficient, the inlet pressure of the melt booster pump will be increased under a constant process water temperature to indirectly increase the inlet pressure of the die, and pressure relief will be accelerated through process water. When smaller open pores are needed or the proportion of open pores needs to be reduced, the inlet pressure of the melt booster pump will be decreased under a constant process water temperature to indirectly decrease the inlet pressure of the die, and pressure relief will slow down through the process water.

Compared with the prior art, the invention has the following advantages:

Compared with airtight micro-porous foamed materials prepared from polymer materials with the same physical property, polymer materials with different physical properties are adopted in the invention and are foamed to form a twining and inter-penetrating air duct structure having proper micro-pore structures and appropriate open pores, these micro-pore structures fulfill good physical properties, such as strength, elasticity modulus and resilience, of the material, and the open pores improve the energy-absorption and energy-storage performance, sense of touch and comfort of the material.

The structure, opening form, density and size of the micro-pores and open pores can be effectively adjusted by regulating the formula and process conditions, the micro-pores can be effectively controlled to account for about 20-99.5% of the material, and the open pores can be effectively controlled to account for about 0.5-80% of the material.

(3) In the preparation process, the pressure-relief expanding speed and rate can be stabilized by controlling the back pressure of the hot melt in the double-screw extruder and the back pressure of the underwater pelletizing chamber, so that the expanding rate of the material is accurately controlled.

(4) Multi-stage stepwise pressure relief is adopted, so that the bubble breakage rate in the expanding process of different polymers can be flexibly controlled to manufacture appropriate composite foamed materials.

(5) The pore diameter of the die is decreased to 0.1-1.9 mm, the pore density of the die is increased, a high-speed variable-frequency pelletizer (3000-8000 rpm) is selected, and the pressure of the die and the flow rate of the melt are adjusted and controlled by maintaining the inlet pressure of the melt pump within 100-150 bar and maintaining the pressure of the process water within 6-40 bar, so that the thermoplastic micro-porous polyurethane elastomer material is spherical and has a particle size of 0.5-2.0 mm after being expanded.

(6) The thermoplastic micro-porous polyurethane elastomer material prepared by the invention has a finer and softer appearance after being molded by hot-pressing with steam.

(7) The polyurethane elastomer material prepared by the invention is suitable for the application fields of foamed materials such as shoes, packages, shock-absorption, heat-insulation, seats, tracks, and solid tires.

### BRIEF DESCRIPTION OF THE DRAWINGS

FIG. 1 is a process flow diagram of the invention;

FIG. 2-FIG. 4 are SEM pictures at different scales of the interior of a micro-porous polyurethane elastomer material prepared by the invention;

FIG. 5-FIG. 8 are SEM pictures at different scales of the surface of the micro-porous polyurethane elastomer material prepared by the invention;

Reference signs: 1, motor; 2, double-screw extruder; 3, first feed inlet; 4, second feed inlet; 5, static mixer; 6, melt pump; 7, die; 8, underwater pelletizing chamber; 9, process water inlet pipe; 10, first-stage process water pressure-relief pipe; 11, second-stage process water pressure-relief pipe; 12, third-stage process water pressure-relief pipe; 13, fourth-stage process water pressure-relief pipe; 14, centrifugal separator; 15, vibrating screen; 16, process water pump assembly.

### DETAILED DESCRIPTION

The invention is expounded below in combination with the accompanying drawings and specific embodiments.

It should be noted that the following embodiments are used for further explaining the invention and should not be interpreted as limitations of the protection scope of the invention. Non-essential improvements and modifications made by those skilled in the art according to the contents of the invention still fall within the protection scope of the invention.

In addition, unless otherwise stated, all raw materials adopted in the invention are commercially-available.

With reference to the following detailed description of desired implementation and embodiments of the invention, the contents of the invention can be more easily understood. All the techniques and scientific terms used in this article, unless otherwise specified, have the meanings generally understood by those normally skilled in the art. In the case of a contradiction, definitions in this specification shall prevail.

For example, the term “prepare from” in this article is equivalent to “include”. The terms “include”, “comprise”, “have”, “contain” or other transformations are intended to refer to non-exclusion inclusion. For example, a composition, step, method, product or device comprising elements listed is not limited to including these elements listed, and may also comprise other elements not specifically listed, or inherent elements of the composition, step, method, product or device.

In the case where quantity, concentration, or other values or parameters are represented by ranges, preferred ranges, or a series of preferred upper limits and preferred lower limits, all ranges defined by any pair of upper range limits or preferred values and lower range limits or preferred values should be appreciated as specifically disclosed no matter whether or not these ranges are independently disclosed. For instance, in the case where the range from 1 to 5 is disclosed, this range intends to comprise a range from 1 to 4, a range from 1 to 3, a range from 1 to 2, ranges from 1 to 2 and from 4 to 5, and ranges from 1 to 3 and from 1 to 5. Unless otherwise specified, any value ranges involved in this article intend to comprise end values as well as all integers and factions within these ranges.

Approximate expressions used in the description and claims to modify quantity does not mean that the invention is limited to a specific quantity and also includes acceptable amendments close to the quantity without causing changes to related basic functions. Correspondingly, the term “approximate” or “about” used for modifying a value intends to express that the invention is not limit to an accurate value. In certain embodiments, the approximate expressions may correspond to the precision of instruments used for value measurement. In the description and claims of this application, range limits can be combined and/or interchanged, and unless otherwise stated, these ranges include all sub-ranges thereof.

In addition, the indefinite article such as “one” in front of elements or components of the invention prescribes no limit to the quantity (the frequency of occurrence) of the elements or components. Therefore, “one” should be interpreted as “one” or “at least one”, and unless in the case where a quantity obviously refers to a singular form, any element or component defined by the singular form also includes the plural form.

“Polymer” is intended to refer to polymer compounds prepared by polymerizing identical or different monomers. The generic term “polymer” includes the terms “homopolymer”, “copolymer”, “terpolymer”, and “interpolymer”.

A thermoplastic micro-porous polyurethane elastomer material with a micro particle size comprises, by weight, 0.1-97% of support frame polymer material, 0.1-97% of pressure-resistant low-resilience polymer material, 0.01-0.5% of nucleating agent, and 0.1-10% of foaming agent.

As a preferred embodiment, the support frame polymer material is a high-molecular weight or high-hardness polymer material, and the pressure-resistant low-resilience polymer material is a low-molecular weight or low-hardness polymer material corresponding to the support frame polymer material.

As a more preferred embodiment, the support frame polymer material is high-molecular weight thermoplastic polyurethane, and the pressure-resistant low-resilience polymer material corresponding to the support frame polymer material is low-molecular weight thermoplastic polyurethane;

or, the support frame polymer material is a high-hardness thermoplastic polymer elastomer, and the pressure-resistant low-resilience polymer material corresponding to the support frame polymer material is a low-hardness thermoplastic polymer elastomer.

As a more preferred embodiment of the above technical solution, the molecular weight Mw of the high-molecular weight polyurethane is 8×10⁴-5×10⁵, and the molecular weight Mw of the low-molecular weight polyurethane is 2×10⁴-2.5×10⁵;

The shore hardness of the high-hardness thermoplastic polymer elastomer is 80 A-75 D, and the shore hardness of the low-hardness thermoplastic polymer elastomer is 30-85 A.

As a preferred embodiment, the nucleating agent is at least one selected from carbon nano-tubes, silicon dioxide, talcum powder, modified calcium carbonate, carbon black and tetrafluoroethylene powder;

The foaming agent is at least one selected from CO₂, N₂, n-butane, n-pentane and isopentane.

As a preferred embodiment, the particle size of the polymer elastomers is 0.5-2 mm.

A method for preparing the thermoplastic micro-porous polyurethane elastomer material with a micro particle size comprises the following steps:

Feeding the support frame polymer material, the pressure-resistant low-resilience polymer material and the nucleating agent via a feed inlet at the front end of a double-screw extruder, feeding the foaming agent from the middle of the double-screw extruder, hot-melting and fully mixing all the raw materials, then further homogenizing hot melt in a static mixer, and afterwards, controlling the pressure of the hot melt and quantitatively delivering the hot melt by a melt pump; and

Pelletizing the hot melt entering an underwater pelletizing chamber from the melt pump via a die, separating particles carried out by process water, and screening and drying the particles to obtain a target product.

As a preferred embodiment, the inlet pressure of the melt pump is controlled to 100-150 bar, the pressure of the process water in the underwater pelletizing chamber is 6-40 bar, and the rotating speed of a pelletizer in the underwater pelletizing chamber is 3000-8000 rpm.

As a further preferred embodiment, the particles are carried out by the process water through a multi-stage pressure-relief expanding process water pipe with a pressure decreased gradually. More preferably, the multi-stage pressure-relief expanding process water pipe is a four-stage process water pipe, wherein a first-stage process water pipe has a water pressure of 6-40 bar, a second-stage process water pipe has a water pressure of 5-35 bar, a third-stage process water pipe has a water pressure of 4-30 bar, and a fourth-stage process water pipe has a water pressure of 3-20 bar.

As a more preferred embodiment, the die is of a porous plate structure, wherein pores in the porous plate structure have a diameter of 0.1-1.9 mm.

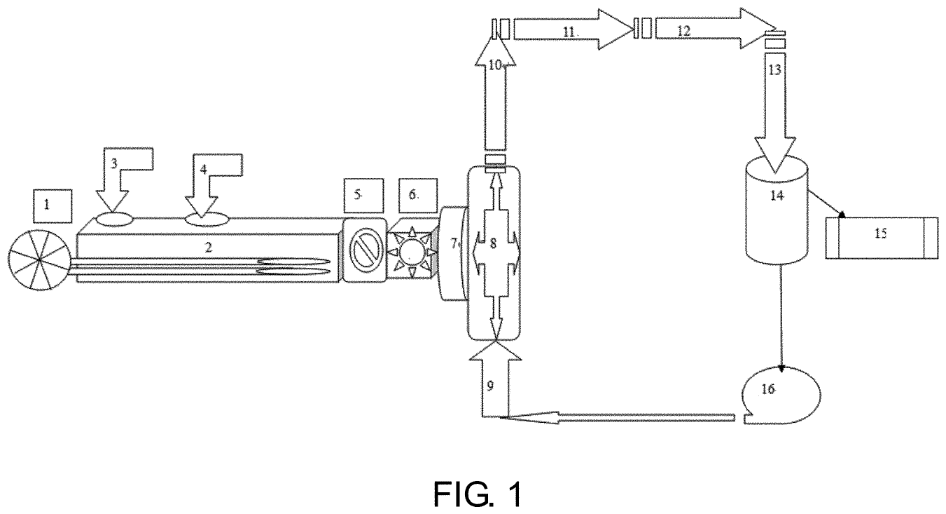

More preferably, the above preparation process as shown in FIG. 1 is detailed as follows: a double-screw extruder 2 is driven by a motor 1 to operate at a speed of 50-900 rpm, a cylinder of the double-screw extruder 2 is set to a temperature of 160-300° C. to make sure that the thermoplastic polymer can be fully hot-melted, the polymer materials and the nucleating agent are fed via a first feed inlet 3 at the front end, and the foaming agent is fed via a second feed inlet 4 in the middle. After being mixed, the materials are heated and sheared by a screw to be hot-melted and enter a static mixer 5 after being fully mixed by the screw, the melt is further homogenized and cooled in the static mixer 5 to make sure that the temperature of the melt is controlled within 120-280° C. specifically as required by the physical properties of a finished product. A melt pump 6 (or a gear pump) is used for controlling the pressure of the melt and quantitatively delivering the melt, and the inlet pressure of the melt pump 6 is controlled within 100-150 bar and the pressure of the melt in a screw cavity of the double-screw extruder 2 is controlled to be stable to make sure that the hot melt of the foaming agent and the nucleating agent is fully mixed and homogenized in a controllable high-pressure environment. The high-pressure hot melt is stably fed into a die 7 of the extruder through the pressure control and quantitative delivery functions of the melt pump 6, wherein the die 7 is of a porous plate structure, and a uniform heating facility is arranged in the die 7 to make sure that the hot melt can stably flow through the die 7. The hot melt delivered out by the melt pump 6 under a high pressure enters an underwater pelletizing chamber 8 via pores of the die 7 and is cut into bean-like particles by a pelletizing cutter rotating at a high speed, wherein the pelletizing cutter in the underwater pelletizing chamber 8 cuts the hot melt underwater. A 6-40 bar pressure generated by 10-90° C. process water under the effect of a process water pump assembly 16 (including a water pump and a water tank) enters the underwater pelletizing chamber 8 via a process water inlet pipe 9, and the rotating speed of a pelletizer in the underwater pelletizing chamber 8 is controlled to about 3000-8000 rpm, so that the high-pressure hot melt extruded out of the die 7 is rapidly cooled by the high-pressure process water and is cut into particles by the pelletizing cutter. A pressure difference between the hot-pressure hot melt and the high-pressure process water can be adjusted by means of the inlet pressure of the melt pump 6 and the pressure of the process water pump assembly 16 to make sure that the initial expanding speed and rate of the polymer cut into particles are controllable and stable in the whole process. In consideration of a short cooling time of the polymer particles and a large difference in crystallization speed of materials in different formulas, the multi-stage pressure-relief expanding process water pipe (preferably a four-stage pressure-relief expanding process water pipe) is particularly designed in this process. According to the principle that the strength and pressure borne by the outer surface of the granular polymer increase along with the increase of the retention time in the process water, the water pressure in a first-stage process water pipe (namely, a first-stage pressure-relief process water pipe 10) is maintained at 6-40 bar, so that the granular melt is partially cooled and is initially expanded in the presence of a pressure difference. The water pressure in a second-stage process water pipe (namely, a second-stage pressure-relief process water pipe 11) is decreased to 5-35 bar by increasing the diameter of the pipe and decreasing the length of the pipe, in this case, the granular melt is further cooled, the strength of the outer surface of the melt is improved, and the melt is expanded again with the increase of the pressure difference. The resistance in a third-stage process water pipe (namely a third-stage pressure-relief process water pipe 12) is reduced to decrease the water pressure to 4-30 bar by increasing the diameter of the pipe and decreasing the length of the pipe, in this case, the granular melt is cooled again, the strength of the outer surface of the granular melt is further improved, the granular melt is expanded again with the increase of the pressure difference, and the expanding speed is decreased to be low because particle crystallization is about to be finished. The resistance in a fourth-stage process water pipe (namely a fourth-stage pressure-relief process water pipe 13) is reduced to decrease the water pressure to 3-20 bar by adjusting the pipe diameter and length of the pipe, in this case, the granular melt continues to be cooled, the strength of the outer surface of the melt is further improved, the granular melt is expanded again with the increase of the pressure difference, and the outer diameter of the particles is constant and stable because the cooling time is long enough, the strength of the outer surfaces of the particles is very high and particle crystallization is almost finished. The expanded granular polymer enters a centrifugal separator 14 together with water, water and expanded particles are separated in a centrifugal separator 14, then the expanded particles enter a vibrating screen 15 and then enter a post-treatment system to generate a finished product which is output, and the process water flows out of the centrifugal separator 14 to enter the process water pump assembly 16. The process is conducted continuously and repeatedly in this way.

In addition, it should be noted that the above disclosure is only one basic formula of the invention. On the basis of the basic formula, those skilled in the art can add other conventional assistants, such as anti-oxidants and anti-aging agents, as actually needed to improve the anti-aging performance of the product.

In the following embodiments, the polyether-type thermoplastic polyurethane is from Byer, Hustman, or the like; and the polyester-type thermoplastic polyurethane is from Byer, Hustman, or the like.

### Embodiment 1

A thermoplastic micro-porous polymer elastomer material with a micro particle size of the invention is prepared according to the following formula and process condition through the technological process shown in FIG. 1:

Wherein, 75% (by weight, the same below) of polyether-type thermoplastic polyurethane with a molecular weight M_{w} of 150K-300K (K refers to kilo), 20% of polyether-type thermoplastic polyurethane with a molecular weight M_{w} of 50K-100K, 4.5% of foaming agent, and 0.5% of nucleating agent are added, wherein the foaming agent is CO2, and the nucleating agent is calcium carbonate. The length-diameter ratio of a double-screw extruder meets L/D=40, the heating temperature of a screw is 160-220° C., the temperature of a static mixer is 140-180° C., the inlet pressure of a melt pump is 100-150 bar, a pressure of process water is about 25 bar, the pressure difference for pressure relief (namely the pressure difference between high-pressure hot melt at an outlet of a die and the process water in an underwater pelletizing chamber) is 90-140 bar, and the rotating speed of a pelletizer in the underwater pelletizing chamber is controlled to about 3000 rpm. In a multi-stage pressure-relief expanding process water pipe, the water pressure in a first-stage process water pipe is controlled to about 20 bar, the water pressure in a second-stage process water pipe is controlled to about 15 bar, the water pressure in a third-stage process water pipe is about 10 bar, and the water pressure in a fourth-stage process water pipe is controlled to about 50 bar.

Finally, a thermoplastic micro-porous polymer elastomer material with a particle size of about 0.5-2.0 mm is prepared through a vibrating screen. It is checked that the polymer product has a twining and inter-penetrating air duct structure formed by micro-pore structures and open pores.

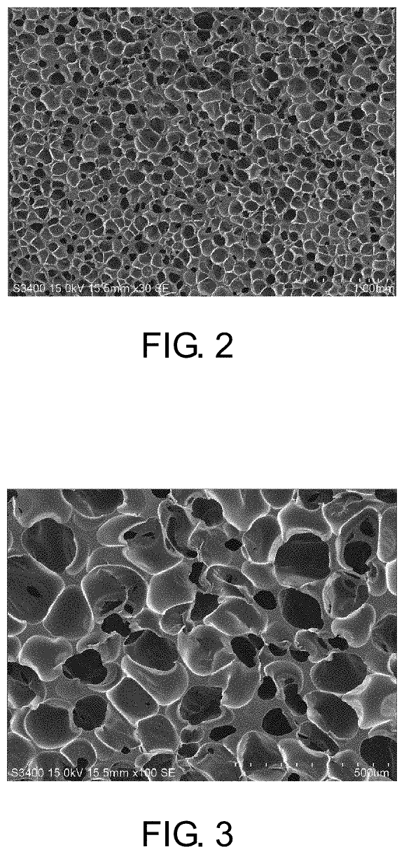

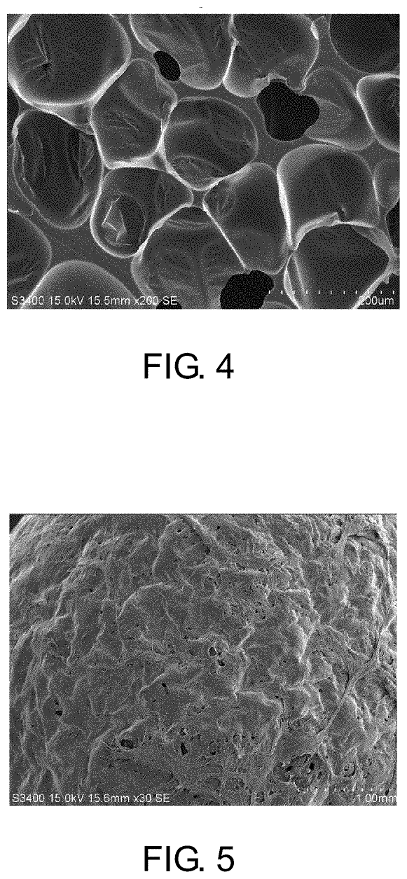

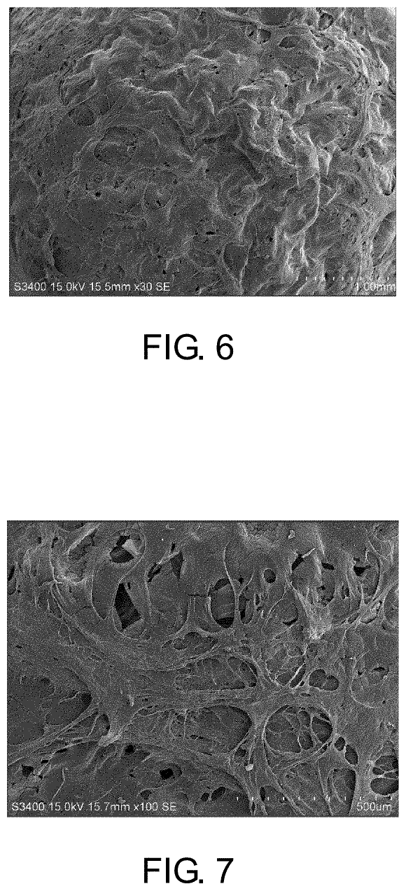

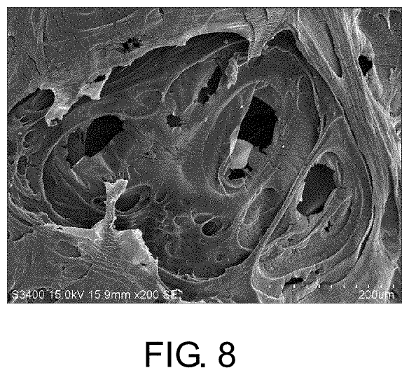

As can be seen from FIG. 2-FIG. 4 which are SEM pictures at different scales of the interior of the micro-porous polyurethane elastomer material prepared in Embodiment 1, the material particle has an obvious twining and inter-penetrating air duct structure formed by micro-pore structures and open pores. As can be seen from FIG. 5-FIG. 8 which are SEM pictures at different scales of the surface of the micro-porous polyurethane elastomer material prepared in Embodiment 1, air ducts extend to the surface of the material particle.

### Embodiment 2

A thermoplastic micro-porous polymer elastomer material with a micro particle size of the invention is prepared according to the following formula and process condition through the technological process shown in FIG. 1:

Wherein, 60% (by weight, the same below) of polyether-type thermoplastic polyurethane with a molecular weight M_{w} of 300K-500K (K refers to kilo), 35% of polyether-type thermoplastic polyurethane with a molecular weight M_{w} of 150K-250K, 4.95% of foaming agent, and 0.05% of nucleating agent are added, wherein the foaming agent is N₂, the nucleating agent is carbon black. The length-diameter ratio of a double-screw extruder meets L/D=56, the heating temperature of a screw is 180-240° C., the temperature of a static mixer is 150-190° C., the inlet pressure of a melt pump is 120-180 bar, the pressure of process water is about 40 bar, a pressure difference for pressure relief (namely the pressure difference between high-pressure hot melt at an outlet of a die and the process water in an underwater pelletizing chamber) is 100-150 bar, and the rotating speed of a pelletizer in the underwater pelletizing chamber is controlled to about 8000 rpm. In a multi-stage pressure-relief expanding process water pipe, the water pressure in a first-stage process water pipe is controlled to about 40 bar, the water pressure in a second-stage process water pipe is controlled to about 35 bar, the water pressure in a third-stage process water pipe is about 30 bar, and the water pressure in a fourth-stage process water pipe is controlled to about 20 bar.

Finally, a thermoplastic micro-porous polymer elastomer material with a particle size of about 0.5-2 mm is prepared through a vibrating screen. It is checked that the polymer product has a twining and inter-penetrating air duct structure formed by micro-pore structures and open pores.

### Embodiment 3

A thermoplastic micro-porous polymer elastomer material with a micro particle size of the invention is prepared according to the following formula and process condition through the technological process shown in FIG. 1:

Wherein, 50% (by weight, the same below) of polyether-type thermoplastic polyurethane with a molecular weight M_{w} of 80K-120K (K refers to kilo), 45% of polyether-type thermoplastic polyurethane with a molecular weight M_{w} of 20K-50K, 4.8% of foaming agent, and 0.2% of nucleating agent are added, wherein the foaming agent is N2, the nucleating agent is a mixture of talcum powder and modified calcium carbonate with a mass ratio of 1:1. The length-diameter ratio of a double-screw extruder meets L/D=48, the heating temperature of a screw is 160-220° C., the temperature of a static mixer is 130-170° C., the inlet pressure of a melt pump is 100-150 bar, the pressure of process water is about 6 bar, a pressure difference for pressure relief (namely the pressure difference between high-pressure hot melt at an outlet of a die and the process water in an underwater pelletizing chamber) is 100-140 bar, and the rotating speed of a pelletizer in the underwater pelletizing chamber is about 6000 rpm. In a multi-stage pressure-relief expanding process water pipe, the water pressure in a first-stage process water pipe is controlled to about 15 bar, the water pressure in a second-stage process water pipe is controlled to about 10 bar, the water pressure in a third-stage process water pipe is about 6 bar, and the water pressure in a fourth-stage process water pipe is controlled to about 4 bar.

Finally, a thermoplastic micro-porous polymer elastomer material with a particle size of about 0.5-2 mm is prepared through a vibrating screen. It is checked that the polymer product has a twining and inter-penetrating air duct structure formed by micro-pore structures and open pores.

### Embodiment 4

A thermoplastic micro-porous polymer elastomer material with a micro particle size of the invention is prepared according to the following formula and process condition through the technological process shown in FIG. 1:

Wherein, 1% (by weight, the same below) of polyether-type thermoplastic polyurethane with a molecular weight M_{w} of 80K-120K (K refers to kilo), 97% of polyether-type thermoplastic polyurethane with a molecular weight M_{w} of 20K-50K, 1.9% of foaming agent, and 0.1% of nucleating agent are added, wherein the foaming agent is N2. The length-diameter ratio of a double-screw extruder meets L/D=48, the heating temperature of a screw is 160-220° C., the temperature of a static mixer is 130-170° C., the inlet pressure of a melt pump is 100-150 bar, the pressure of process water is about 10 bar, a pressure difference for pressure relief (namely the pressure difference between high-pressure hot melt at an outlet of a die and the process water in an underwater pelletizing chamber) is 90-140 bar, and the rotating speed of a pelletizer in the underwater pelletizing chamber is about 5000 rpm. In a multi-stage pressure-relief expanding process water pipe, the water pressure in a first-stage process water pipe is controlled to about 10 bar, the water pressure in a second-stage process water pipe is controlled to about 7 bar, the water pressure in a third-stage process water pipe is about 4 bar, and the water pressure in a fourth-stage process water pipe is controlled to about 3 bar.

Finally, a thermoplastic micro-porous polymer elastomer material with a particle size of about 0.5-2.0 mm is prepared through a vibrating screen is about 0.5-0.2 mm. It is checked that the polymer product has a twining and inter-penetrating air duct structure formed by micro-pore structures and open pores.

### Embodiment 5

A thermoplastic micro-porous polymer elastomer material with a micro particle size of the invention is prepared according to the following formula and process condition through the technological process shown in FIG. 1:

Wherein, 97% (by weight, the same below) of polyether-type thermoplastic polyurethane with a molecular weight M_{w} of 120K-180K (K refers to kilo), 1% of polyether-type thermoplastic polyurethane with a molecular weight M_{w} of 20K-50K, 1.7% of foaming agent, and 0.3% of nucleating agent are added, wherein the foaming agent is prepared from CO₂ and N₂ with a volume ratio of 1:1, the nucleating agent is a mixture of talcum powder and modified calcium carbonate with a mass ratio of 1:1. The length-diameter ratio of a double-screw extruder meets L/D=40, the heating temperature of a screw is 180-230° C., the temperature of a static mixer is 150-190° C., the inlet pressure of a melt pump is 140-180 bar, the pressure of process water is about 20 bar, a pressure difference for pressure relief (namely the pressure difference between high-pressure hot melt at an outlet of a die and the process water in an underwater pelletizing chamber) is 100-160 bar, and the rotating speed of a pelletizer in the underwater pelletizing chamber is controlled to about 4000 rpm. In a multi-stage pressure-relief expanding process water pipe, the water pressure in a first-stage process water pipe is controlled to about 20 bar, the water pressure in a second-stage process water pipe is controlled to about 16 bar, the water pressure in a third-stage process water pipe is about 2 bar, and the water pressure in a fourth-stage process water pipe is controlled to about 8 bar.

Finally, a thermoplastic micro-porous polymer elastomer material with a particle size of about 0.5-2 mm is prepared through a vibrating screen. It is checked that the polymer product has a twining and inter-penetrating air duct structure formed by micro-pore structures and open pores.

### Embodiment 6

Embodiment 6 is substantially identical with Embodiment 1 except in that the formula of raw materials is as follows:

80% (by weight, the same below) of polyester-type thermoplastic polyurethane with a molecular weight M_{w} of 200K-300K (K refers to kilo), 18.9% of polyester-type thermoplastic polyurethane with a molecular weight M_{w} of 50K-100K, 1% of foaming agent, and 0.1% of nucleating agent are added, wherein the foaming agent is prepared from CO₂ and N₂ with a volume ratio of 1:1, and the nucleating agent is a mixture of calcium carbonate and tetrafluoroethylene powder with a mass ratio of 1:1.

Finally, a thermoplastic micro-porous polymer elastomer material prepared through a vibrating screen also has a composite pore structure formed by micro-pore structures (closed-pore structures) and open-pore structures. Referring to the pore structure shown in FIG. 2-FIG. 8, the micro-pore structures account for about 70-80% of the material, and the open-pore structures account for about 15-30% of the material.

### Embodiment 7

Embodiment 7 is substantially identical with Embodiment 1 except in that the formula of raw materials is as follows:

80% (by weight, the same below) of polyester-type thermoplastic polyurethane with the shore hardness of 80 A, 19.5% of polyester-type thermoplastic polyurethane with the shore hardness of 30 A, 0.4% of foaming agent, and 0.1% of nucleating agent are added, wherein the foaming agent is prepared by mixing CO₂ and N₂ according to a weight ratio of 1:1, and the nucleating agent is a mixture of carbon nano-tubes, talcum powder and calcium carbonate.

Finally, a thermoplastic micro-porous polymer elastomer material prepared through a vibrating screen also has a composite pore structure formed by micro-pore structures (closed-pore structures) and open-pore structures. Referring to the pore structure shown in FIG. 2-FIG. 8, the micro-pore structures account for about 70-80% of the material, and the open-pore structures account for about 15-30% of the material.

### Embodiment 8

Embodiment 8 is substantially identical with Embodiment 7 except in that the formula of raw materials is as follows:

70% (by weight, the same below) of polyester-type thermoplastic polyurethane with the shore hardness of 75 D, 27.5% of polyester-type thermoplastic polyurethane with the shore hardness of 85 A, 2% of foaming agent, and 0.5% of nucleating agent are added, wherein the foaming agent is prepared by mixing CO₂ and N₂ according to the weight ratio of 1:1, and the nucleating agent is a mixture of carbon nano-tubes, talcum powder and calcium carbonate.

Finally, a thermoplastic micro-porous polymer elastomer material prepared through a vibrating screen also has a composite pore structure formed by micro-pore structures (closed-pore structures) and open-pore structures. Referring to the pore structure shown in FIG. 2-FIG. 8, the micro-pore structures account for about 60-70% of the material, and the open-pore structures account for about 25-40% of the material.

### Embodiment 9

Embodiment 9 is substantially identical with Embodiment 7 except in that the shore hardness of the high-hardness polyester-type thermoplastic polyurethane in the formula is 90 A, and the shore hardness of the low-hardness polyester-type thermoplastic polyurethane is 50 A.

Finally, a thermoplastic micro-porous polymer elastomer material prepared through a vibrating screen also has a composite pore structure formed by micro-pore structures (closed-pore structures) and open-pore structures. Referring to the pore structure shown in FIG. 2-FIG. 8, the micro-pore structures account for about 70-80% of the material, and the open-pore structures account for about 15-30% of the material.

### Embodiment 10-Embodiment 12

Embodiment 10-Embodiment 12 are identical with Embodiment 1 except in that the foaming agent is n-butane, n-pentane or isopentane.

A thermoplastic micro-porous polyurethane elastomer material prepared in Embodiment 10-Embodiment 12 through a vibrating screen also has a composite pore structure formed by micro-pore structures (closed-pore structures) and open-pore structures. Refer to the pore structure shown in FIG. 2-FIG. 8.

### Embodiment 13

Embodiment 13 is identical with Embodiment 1 except in that particles entering the underwater pelletizing chamber are directly brought out by process water at a basically stable temperature of 40-50° C. and a pressure of 4-8 bar, and are then cooled and molded by means of pressure relief.

Finally, a thermoplastic micro-porous polymer elastomer material prepared through a vibrating screen also has a composite pore structure formed by micro-pore structures (closed-pore structures) and open-pore structures. Refer to the pore structure shown in FIG. 2-FIG. 8. Compared with the foamed particles in Embodiment 1, parts of pores of foamed particles in this embodiment are punctured, and the distribution uniformity of particle sizes is poor.

### Embodiment 14

Compared with Embodiment 1, in this embodiment, a conventional autoclave foaming process is adopted, the foaming temperature is about 150° C., and the pressure is about 15 Mpa.

Finally, foamed particles prepared through a vibrating screen have a composite pore structure formed by micro-pore structures (closed-pore structures) and open-pore structures, as shown in FIG. 2-FIG. 8. However, the pore structure is instable and is prone to shrinkage.

### Comparative Embodiment 1

Comparative Embodiment 1 is identical with Embodiment 1 except in that polymer materials (polyether-type thermoplastic polyurethane) in this embodiment are 150-300K polyether-type thermoplastic polyurethane.

### Comparative Embodiment 2

Comparative Embodiment 2 is identical with Embodiment 7 except in that polymer materials in this embodiment are polyester-type thermoplastic polyurethane with the shore hardness of 80 A.

### Comparative Embodiment 3

Comparative Embodiment 3 is identical with Embodiment 10 except in that polymer materials in this embodiment are modified low-melting point polyester PET (that is, no polyester-type polyurethane is added).

Finally, the pore structures of the foamed materials prepared in Comparative Embodiments 1-3 are detected and analyzed, the surfaces of foamed particles obtained in these three comparative embodiments are all continuous surfaces, it can be found by cutting and scanning the particles that the interior of the foamed particles are basically of a closed-pore structure and does not have an open-pore structure extending to the surface in FIG. 5-FIG. 8 of Embodiment 1, and the foaming rate is obviously lower than that of the formula including two polymer materials.

As can be seen from the above embodiments and comparative embodiments, compared with foamed particles of a closed-pore structure prepared from polymers with the same physical properties, the formula of the foamed particle of the invention is improved by adopting two polymer materials with different physical properties, and the foamed particle of a composite pore structure formed by open pores and closed pores is prepared by means of the difference in foaming capacity of the foaming agent in the two polymer materials in the foaming process.

Those ordinarily skilled in the art can understand and use the invention with reference to the description of the above embodiments. Those skilled in the art can easily make various modifications to these embodiments and apply the general principle of the invention to other embodiments without creative labor. Therefore, the invention is not limited to the above embodiments, and all improvements and modifications made by those skilled in the art should also fall within the protection scope of the invention.

1. A thermoplastic micro-porous polyurethane elastomer material with a micro particle size, comprising, by weight, 1-97% of a support frame polymer material, 1-97% of a pressure-resistant low-resilience polymer material, 0.01-0.5% of a nucleating agent, and 0.1-10% of a foaming agent.

2. The thermoplastic micro-porous polyurethane elastomer material with a micro particle size according to claim 1, wherein the support frame polymer material is a high-molecular weight or high-hardness polymer material, and the pressure-resistant low-resilience polymer material is a low-molecular weight or low-hardness polymer material corresponding to the support frame polymer material.

3. The thermoplastic micro-porous polyurethane elastomer material with a micro particle size according to claim 2, wherein the support frame polymer material is a high-molecular weight thermoplastic polyurethane, and the pressure-resistant low-resilience polymer material corresponding to the support frame polymer material is a low-molecular weight thermoplastic polyurethane; or
the support frame polymer material is a high-hardness thermoplastic polymer elastomer, and the pressure-resistant low-resilience polymer material corresponding to the support frame polymer material is a low-hardness thermoplastic polymer elastomer.

4. The thermoplastic micro-porous polyurethane elastomer material with a micro particle size according to claim 3, wherein the high-molecular weight thermoplastic polyurethane has a molecular weight of 8×10⁴-5×10⁵, and the low-molecular weight thermoplastic polyurethane has a molecular weight of 2×10⁴-2.5×10⁵; or
the high-hardness thermoplastic polymer elastomer has a shore hardness of 80 A-75 D, and the low-hardness thermoplastic polymer elastomer has a shore hardness of 30-85 A.

5. The thermoplastic micro-porous polyurethane elastomer material with a micro particle size according to claim 1, wherein the nucleating agent is at least one selected from carbon nano-tubes, silicon dioxide, talcum powder, modified calcium carbonate, carbon black and tetrafluoroethylene powder; and
the foaming agent is at least one selected from CO2, N2, n-butane, n-pentane and isopentane.

6. The thermoplastic micro-porous polyurethane elastomer material with a micro particle size according to claim 1, wherein the thermoplastic micro-porous polyurethane elastomer material have a particle size of 0.5-2 mm.

7. A method for preparing the thermoplastic micro-porous polyurethane elastomer material with a micro particle size according to claim 1, comprising following steps:
(1) feeding the support frame polymer material, the pressure-resistant low-resilience polymer material and the nucleating agent via a feed inlet at a front end of a double-screw extruder, feeding the foaming agent from a middle of the double-screw extruder, hot-melting and fully mixing all raw materials, then further homogenizing a hot melt in a static mixer, and afterwards, controlling a pressure of the hot melt and quantitatively delivering the hot melt by a melt pump; and
(2) pelletizing the hot melt entering an underwater pelletizing chamber from the melt pump via a die, separating particles carried out by process water, and screening and drying the particles to obtain the thermoplastic micro-porous polyurethane elastomer material with a micro particle size.

8. The method for preparing the thermoplastic micro-porous polyurethane elastomer material with a micro particle size according to claim 7, wherein an inlet pressure of the melt pump is controlled to 100-200 bar, a pressure of the process water in the underwater pelletizing chamber is 6-40 bar, and a rotating speed of a pelletizer in the underwater pelletizing chamber is 3000-8000 rpm.

9. The method for preparing the thermoplastic micro-porous polyurethane elastomer material with a micro particle size according to claim 8, wherein the particles are carried out by the process water through a multi-stage pressure-relief expanding process water pipe with the pressure decreased gradually; the multi-stage pressure-relief expanding process water pipe is a four-stage process water pipe, wherein a first-stage process water pipe has a water pressure of 6-40 bar, a second-stage process water pipe has a water pressure of 5-35 bar, a third-stage process water pipe has a water pressure of 4-30 bar, and a fourth-stage process water pipe has a water pressure of 3-20 bar.

10. The method for preparing the thermoplastic micro-porous polyurethane elastomer material with a micro particle size according to claim 7, wherein the die is of a porous plate structure, wherein pores in the porous plate structure have a diameter of 0.1-1.9 mm.

11. A method for preparing the thermoplastic micro-porous polyurethane elastomer material with a micro particle size according to claim 2, comprising following steps:
(1) feeding the support frame polymer material, the pressure-resistant low-resilience polymer material and the nucleating agent via a feed inlet at a front end of a double-screw extruder, feeding the foaming agent from a middle of the double-screw extruder, hot-melting and fully mixing all raw materials, then further homogenizing a hot melt in a static mixer, and afterwards, controlling a pressure of the hot melt and quantitatively delivering the hot melt by a melt pump; and
(2) pelletizing the hot melt entering an underwater pelletizing chamber from the melt pump via a die, separating particles carried out by process water, and screening and drying the particles to obtain the thermoplastic micro-porous polyurethane elastomer material with a micro particle size.

12. A method for preparing the thermoplastic micro-porous polyurethane elastomer material with a micro particle size according to claim 3, comprising following steps:
(1) feeding the support frame polymer material, the pressure-resistant low-resilience polymer material and the nucleating agent via a feed inlet at a front end of a double-screw extruder, feeding the foaming agent from a middle of the double-screw extruder, hot-melting and fully mixing all raw materials, then further homogenizing a hot melt in a static mixer, and afterwards, controlling a pressure of the hot melt and quantitatively delivering the hot melt by a melt pump; and
(2) pelletizing the hot melt entering an underwater pelletizing chamber from the melt pump via a die, separating particles carried out by process water, and screening and drying the particles to obtain the thermoplastic micro-porous polyurethane elastomer material with a micro particle size.

13. A method for preparing the thermoplastic micro-porous polyurethane elastomer material with a micro particle size according to claim 4, comprising following steps:
(1) feeding the support frame polymer material, the pressure-resistant low-resilience polymer material and the nucleating agent via a feed inlet at a front end of a double-screw extruder, feeding the foaming agent from a middle of the double-screw extruder, hot-melting and fully mixing all raw materials, then further homogenizing a hot melt in a static mixer, and afterwards, controlling a pressure of the hot melt and quantitatively delivering the hot melt by a melt pump; and
(2) pelletizing the hot melt entering an underwater pelletizing chamber from the melt pump via a die, separating particles carried out by process water, and screening and drying the particles to obtain the thermoplastic micro-porous polyurethane elastomer material with a micro particle size.

14. A method for preparing the thermoplastic micro-porous polyurethane elastomer material with a micro particle size according to claim 5, comprising following steps:
(1) feeding the support frame polymer material, the pressure-resistant low-resilience polymer material and the nucleating agent via a feed inlet at a front end of a double-screw extruder, feeding the foaming agent from a middle of the double-screw extruder, hot-melting and fully mixing all raw materials, then further homogenizing a hot melt in a static mixer, and afterwards, controlling a pressure of the hot melt and quantitatively delivering the hot melt by a melt pump; and
(2) pelletizing the hot melt entering an underwater pelletizing chamber from the melt pump via a die, separating particles carried out by process water, and screening and drying the particles to obtain the thermoplastic micro-porous polyurethane elastomer material with a micro particle size.

15. A method for preparing the thermoplastic micro-porous polyurethane elastomer material with a micro particle size according to claim 6, comprising following steps:
(1) feeding the support frame polymer material, the pressure-resistant low-resilience polymer material and the nucleating agent via a feed inlet at a front end of a double-screw extruder, feeding the foaming agent from a middle of the double-screw extruder, hot-melting and fully mixing all raw materials, then further homogenizing a hot melt in a static mixer, and afterwards, controlling a pressure of the hot melt and quantitatively delivering the hot melt by a melt pump; and
(2) pelletizing the hot melt entering an underwater pelletizing chamber from the melt pump via a die, separating particles carried out by process water, and screening and drying the particles to obtain the thermoplastic micro-porous polyurethane elastomer material with a micro particle size.
